(19) United States
(12) Patent Application Publication
(10) Pub. No.: US 2003/0190901 A1
(43) Pub. Date: Oct. 9, 2003

(54) Direct conversion receiving unit

(75) Inventors: Shinji Miya, Atsugi-shi (JP); Yuro Yoshizawa, Atsugi-shi (JP)

Correspondence Address: Finnegan, Henderson, Farabow,, Garrett & Dunner, L.L.P., 1300 I Street, N.W., Washington, DC, 20005-3315, US

(73) Assignee: ASAHI KASEI MICROSYSTEMS CO., LTD

(21) Appl. No.: 10/406,314

(22) Filed: Apr. 4, 2003

(30) Foreign Application Priority Data
Apr. 8, 2002 (JP) 2002-105440

(51) Int. Cl. H04B 7/00; H04B 1/06

(52) U.S. Cl. 455/265; 455/264

(57) ABSTRACT

A direct conversion receiving unit includes an oscillation circuit (50) whose oscillation frequency fvco is (N/(N+1))×fR, where fR is a receiving frequency. The output of the oscillation circuit (50) is divided into two parts, one of which is converted to the frequency of (1/(N+1))×fR by a divide-by-N circuit (52). Mixing the two frequencies (1/(N+1))×fR and fvco=(N/(N+1))×fR generates the frequency fR, which is supplied to conversion mixers (38 and 44) as a local input. The receiving unit requires only one oscillation circuit, and excludes all the circuits that handle a frequency higher than fR, enabling a small size and low current consumption configuration.

This application claims priority from Japanese Patent Application No. 2002-105440 filed Apr. 8, 2002, which is incorporated herewith by reference.

### BACKGROUND OF THE INVENTION

1. Field of the Invention

The present invention relates to a receiving unit used in a radio communication system, and particularly to a direct conversion receiving unit that converts a radio frequency signal to a baseband signal by a single conversion mixer.

2. Description of the Related Art

Recently, the direct conversion system has become increasingly important in receiving unites in a radio communication system, and particularly in receiving unites in mobile telephone terminals which demand reduction in size, weight and cost.

FIG. 1 is a block diagram showing a configuration of a conventionally known direct conversion receiving unit. The direct conversion system shown in FIG. 1 has the following advantages over a superheterodyne system, a well-known radio receiving technique (an example of which is shown in FIG. 2).

(1) Since it simplifies the system, it can facilitate size reduction and integration into an IC circuit.

(2) It can eliminate a bandpass filter (IF filter shown in FIG. 2) for an intermediate frequency (IF) signal in the superheterodyne system.

(3) Since it need not concern about the desensitization because of the image receiving involved in the superheterodyne system, it can ease technical demands on a filter (RF filter shown in FIG. 2) for a receiving frequency signal.

In addition, as for the filters (IF filter and RF filter) of the foregoing (2) and (3), a large-capacity, high-performance mobile communication system such as a mobile telephone system usually employs high-performance and rather bulky passive components such as surface acoustic wave (SAW) filters or dielectric filters. Thus, eliminating these filters and easing the technical demands are the advantages of the direct receiving system. Consequently, the direct receiving system with the foregoing (1)-(3) characteristics can be considered as an effective receiving system to reduce size, weight and cost in the mobile telephone terminal.

In practice, however, the superheterodyne system has been used yet. This is because there are some problems about the circuit operation that must be solved to implement the direct receiving system. The most important problems of them are (i) a problem of “desensitization” arising from the DC offset due to the so-called “self-mixing”; and (ii) a problem of “oscillation destabilization” arising from a circulation of a signal with a frequency close to the oscillation frequency into the oscillation circuit. These problems will be described below.

First, consider the simplest case of the direct conversion system. As shown in FIG. 3, an oscillation circuit directly generates a local signal (frequency fLo) with the same frequency as the central frequency (carrier frequency) fR of the received signal (called “receiving frequency” from now on). The local signal is mixed with the received signal by an ordinary mixer to produce a baseband signal (FIG. 3 is a block diagram showing a configuration of a direct conversion receiving unit that generates the receiving frequency directly by the oscillation circuit). Thus, a baseband signal BB(t) is output from the mixer by multiplying the received signal by the local signal by the conversion mixer, when the received signal is represented as fR(t)=sin (ω₀t+α1)+BB(t) and the local signal is represented as fLo(t)=sin (ω₀t+α2) as the functions of the time t.

This is the direct receiving system. FIG. 1 is a block diagram showing a configuration that generalizes its local input. Although the leakage of FIG. 1 has two conversion mixers, it corresponds to a major digital communication system of today, the so-called quadrature demodulator, which demodulates the I signal and Q signal independently to produce I- and Q-quadrature baseband signals. More specifically, as shown in FIG. 1, the local signal is split and supplied to the two mixers so that the mixers can produce the signals with their phases shifted by 90 degrees. Thus, the I and Q quadrature demodulators are configured by providing the received signal itself or the local signal with the phases of zero degree and 90 degrees.

If the local signal leaks to the input side of the received signal or the received signal leaks to the local input terminal in FIG. 1, that is, if the party signal circulates to the input side of the received signal or local input terminal, a pseudo DC output is produced in conjunction with the baseband signal BB(t). Thus, the ratio of the signal energy to the total energy of the output frequency band reduces, thereby decreasing the ratio of the baseband signal in the output signal. This will reduce the receiving sensitivity as compared with the case where no pseudo DC output is present. This is the problem of “desensitization” due to the “self-mixing” mentioned in the foregoing (i). Here, the term “input side of the received signal” refers to the input side of an LNA (low-noise amplifier), or the input side of the foregoing conversion mixer.

FIGS. 6A and 6B are diagrams illustrating the self-mixing due to the signal leakage.

When the frequency fvco of the oscillation circuit is matched to the receiving frequency fR as shown in FIG. 3, a part of the comparatively large output of the oscillation circuit can leak to the input side of the received signal, thereby making the self-mixing problem more serious.

Furthermore, the configuration as shown in FIG. 3 is likely to have a problem at the oscillation circuit side. More specifically, a large received signal will bring about the destabilization of the oscillation circuit because of the disturbance due to the same or proximate frequency signal that leaks to the oscillation circuit. Thus, it is likely that the oscillation frequency becomes unstable depending on time, and the oscillation output is degraded by noise and spurious components, generating a low purity signal. This is the problem of the “oscillation destabilization” due to the signal leakage mentioned in the foregoing (2).

As an effective method to circumvent these two problems, the “desensitization” due to the “self-mixing” and the “oscillation destabilization”, there is a technique that differentiates the frequency fvco of the oscillation circuit from the local frequency fLo (=fR). In this case, the frequency fvco of the oscillation circuit is converted to the frequency fLo through a frequency converter and supplied to the mixer. The technique can usually prevent the problem of the “desensitization” due to the “self-mixing” even if the fvco with large signal intensity leaks to the input side of the received signal. This is because the frequency caused by the “self-mixing” due to the circulation is fvco±fLo, and hence the component can be perfectly removed from the baseband output signal on the frequency axis. In addition, even if the large received signal leaks to the oscillation circuit, its frequency can be sufficiently separated apart from the oscillation frequency, making it possible to suppress the occurrence of the “oscillation destabilization”.

As described above, the two problems the direct conversion system presents, that is, the “desensitization” due to the “self-mixing” and “oscillation destabilization”, can be avoided by preventing the oscillation circuit from directly oscillating the frequency fLo (=fR). In other words, a practical direct conversion receiving unit can be configured by sufficiently reducing the possibility of the “desensitization” due to the “self-mixing” and “oscillation destabilization” by the technique that interposes the frequency converter between the local oscillation circuit and the local input to the conversion mixers.

As conventional direct conversion receiving unites that circumvent the problems by the foregoing technique, circuit configurations as shown in FIGS. 4 or 5 are known. The two configurations are distinguished in terms of the frequency selection of the oscillator circuit, and the concrete configuration of the frequency converter interposed between the oscillation circuit and the local input side of the conversion mixers.

The circuit shown in FIG. 4 sets the frequency fvco=2×fLo (=2×fR). In other words, the oscillation circuit in the configuration generates the frequency twice the frequency of the local signal used by the conversion mixers. Accordingly, the frequency converter interposed between the oscillation circuit and the conversion mixers must be a divide-by-2 circuit. More generally, it is possible to set the oscillation frequency at fvco=N×fR, and to use a divide-by-N circuit as the frequency converter, where N is an integer greater than one.

On the other hand, the circuit as shown in FIG. 5 sets the local signal frequency fLo=fvco1±fvco2. The 15 configuration has two oscillation circuits that oscillate the frequencies fvco1 and fvco2. In this case, a circuit for carrying out the addition and subtraction of the frequencies fvco1 and fvco2, that is, an ordinary mixer is used as the frequency converter.

Incidentally, the configuration as shown in FIG. 5 includes the mixer as the frequency converter in addition to the mixers for the direct conversion receiving. Thus, the two types of mixers are distinguished by calling them local mixer and conversion mixers, respectively.

To apply the direct conversion receiving unit to the mobile telephone terminals and the like of the mobile communication, it is not enough to circumvent the problem of the “desensitization” due to the “self-mixing” and “oscillation destabilization” to implement a practical device.

To explain the reason, another drawback of the direct conversion system for practical use will be described by comparing the direct conversion receiving unit shown in FIG. 1 with the conventional superheterodyne system shown in FIG. 2.

As described above, digital communication systems are the mainstream of the large-capacity mobile communication systems such as mobile telephones, and most of them use the quadrature demodulation with the I and Q outputs for the signal demodulation as shown in FIGS. 1 and 2. In addition, as described in connection with FIG. 1, such a configuration requires two conversion mixers, one for I side and the other for Q side. However, the two conversion mixers of FIGS. 1 and 2 differ greatly. Although the two conversion mixers of FIG. 2 operate at the IF frequency, the two conversion mixers of FIG. 1 are supplied with the input signal with the frequency fR (=fLo).

Generally, the two conversion mixers of FIGS. 1 and 2 differ greatly in current consumption for driving them because the IF frequency is considerably lower than the frequency fR. More specifically, the configuration of FIG. 1 requires two mixers that operate at the highest frequency fR in the receiving path. In contrast, as for the mixer operating at the frequency fR, the configuration of FIG. 2 requires only one mixer, the so-called down-converter, for converting the received signal from the frequency fR to IF.

Thus, the superheterodyne system can usually reduce the total current consumption of the receiving unit in its entirety because it includes a smaller number of the mixers operating at the high frequency than the direct conversion system. In other words, the current consumption of the direct conversion system is generally greater than that of the superheterodyne system, which constitutes another drawback of the direct conversion system. In particular, the drawback has large effect on the practicality when these systems are applied to the battery-operated mobile telephone terminals.

In view of the foregoing explanation, when applying it to the mobile telephone terminal, the direct conversion receiving unit must be configured such that it can not only effectively implement the size, weight and cost reduction of the mobile telephone terminal, but also reduce its current consumption.

Let us review the configuration of the conventionally known direct conversion receiving unit in terms of this point.

As for the circuit configuration shown in FIG. 4, although its entire configuration including the frequency converters is preferable because of its simplicity, it requires twice the frequency fR as the frequency fvco, which increases the current consumption. Generally, as the frequency increases, the oscillation circuit, frequency dividing circuit and other peripheral circuits must drive their transistors and the like with greater current to carry out the same performance.

As for the circuit configuration shown in FIG. 5, when it employs the frequency configuration satisfying the relationship fLo=fvco1+fvco2, it can exclude operation circuits that operate at a frequency higher than fR from the entire configuration. Accordingly, it can eliminate the problem involved in the configuration of FIG. 4. The configuration of FIG. 5, however, requires two oscillation circuits, which presents a problem of increasing the size, cost and current consumption of the receiving unit.

### SUMMARY OF THE INVENTION

The present invention is implemented to solve the foregoing problems. It is therefore an object of the present invention to provide an intensely practical direct conversion receiving unit preferably used as the receiving unit of a mobile telephone terminal by eliminating the problem of the configuration of FIG. 4 in that it requires the circuits (oscillation circuit and others) operating at the frequency higher than the receiving frequency fR, and the problem of the configuration of FIG. 5 in that it requires the two oscillation circuits.

In other words, the object of the present invention is to provide a direct conversion receiving unit with a configuration requiring only one oscillation circuit and excluding all the circuits that operate at the frequency higher than the receiving frequency fR.

According to one aspect of the present invention, there is provided a direct conversion receiving unit for receiving a received signal with a receiving frequency fR, the receiving unit comprising: an oscillation circuit for generating an oscillation signal with an oscillation frequency of {N/(N+1)}·fR, where N is an integer greater than one; a frequency conversion circuit for receiving the oscillation signal with the oscillation frequency of {N/(N+1)}·fR, and for converting the oscillation signal to a signal with an output frequency of fR; and a mixer for receiving the received signal with the receiving frequency of fR, and the signal with the output frequency of fR which the frequency conversion circuit outputs, and for restoring a baseband signal received.

Here, the frequency conversion circuit may include: a divide-by-N circuit for receiving the oscillation signal with the oscillation frequency of {N/(N+1)}·fR, and for producing a signal with an output frequency of {1/(N+1)}·fR; and a mixer for receiving the oscillation signal with the oscillation frequency of {N/(N+1)}·fR from the oscillation circuit and the signal with the output frequency of {1/(N+1)}·fR from the divide-by-N circuit, and for producing the signal with the output frequency of fR.

The mixer may be in the form of single sideband mixing.

The number N may be two.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a block diagram showing a configuration of a conventionally known direct conversion receiving unit;

FIG. 2 is a block diagram showing a configuration of a conventionally known superheterodyne receiving unit;

FIG. 3 is a block diagram showing a configuration of a direct conversion receiving unit with an oscillation circuit that directly generates the receiving frequency;

FIG. 4 is a block diagram showing a concrete circuit of a direct conversion receiving unit configured using a prior art;

FIG. 5 is a block diagram showing another concrete circuit of a direct conversion receiving unit configured using a prior art;

FIG. 6A is a diagram illustrating self-mixing due to the leakage of a signal;

FIG. 6B is a diagram illustrating self-mixing due to the leakage of a signal;

FIG. 7 is a block diagram showing a configuration of a first embodiment in accordance with the present invention;

FIG. 8 is a block diagram showing a configuration of a second embodiment in accordance with the present invention; and

FIG. 9 is a graph illustrating a spurious spectrum at a local mixer output section in the embodiments.

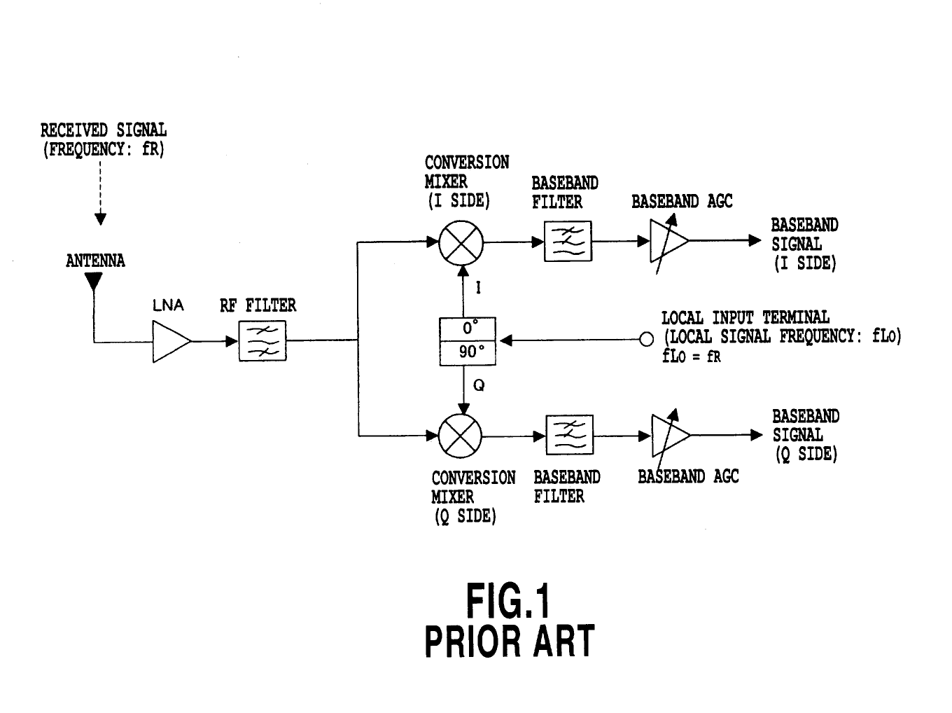

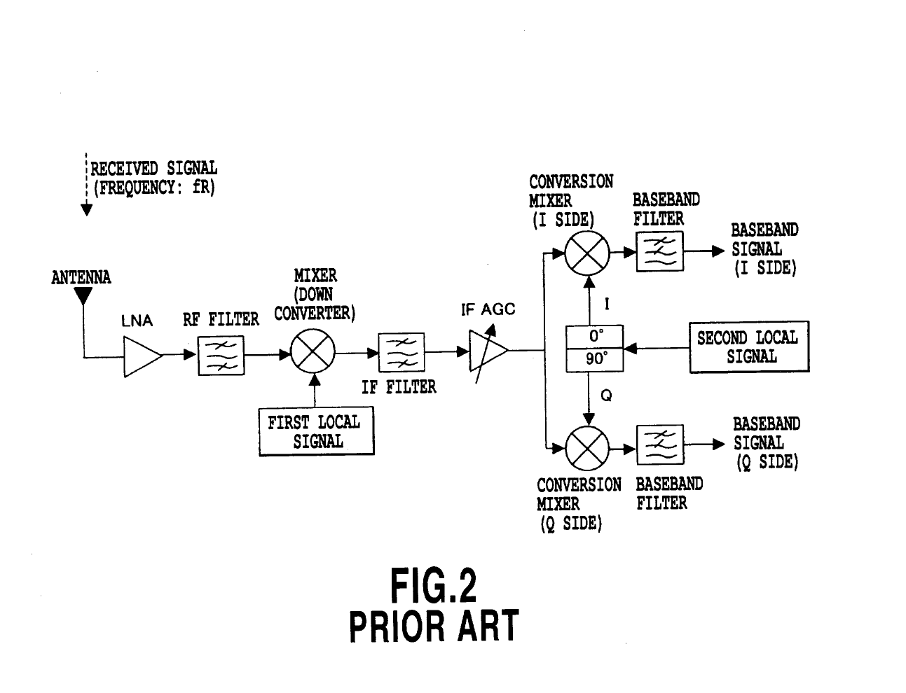

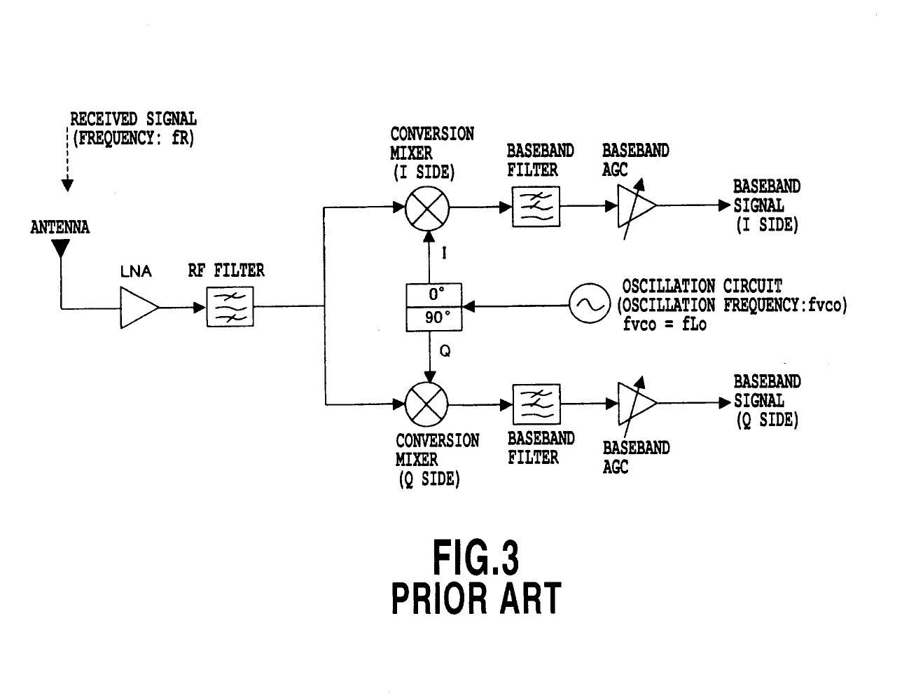

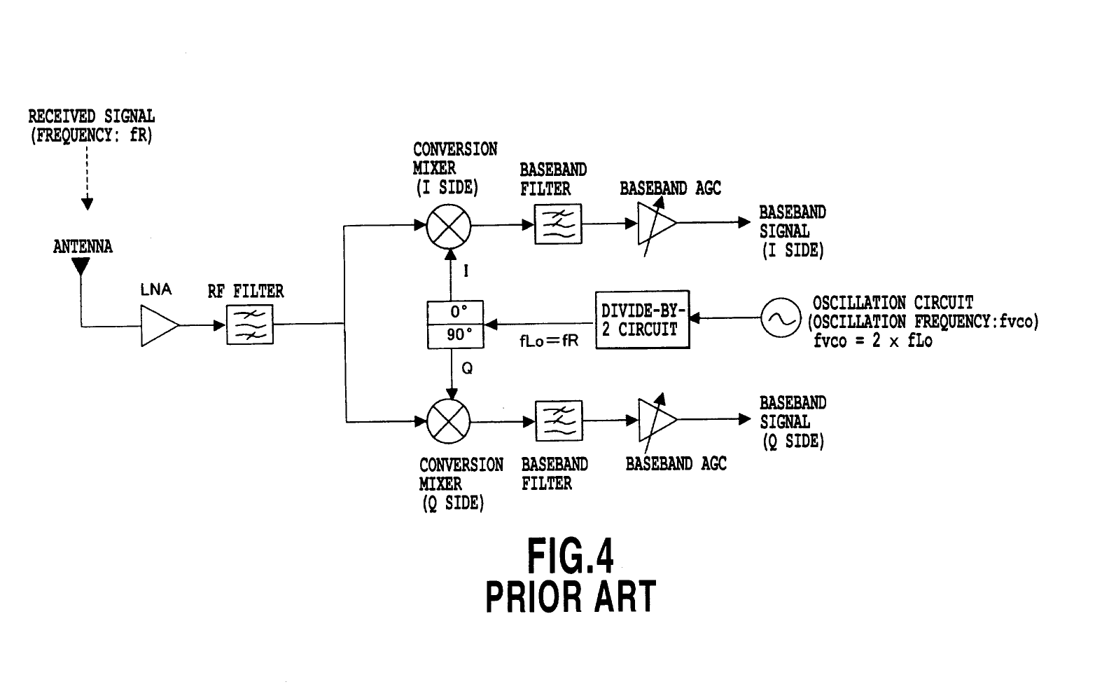

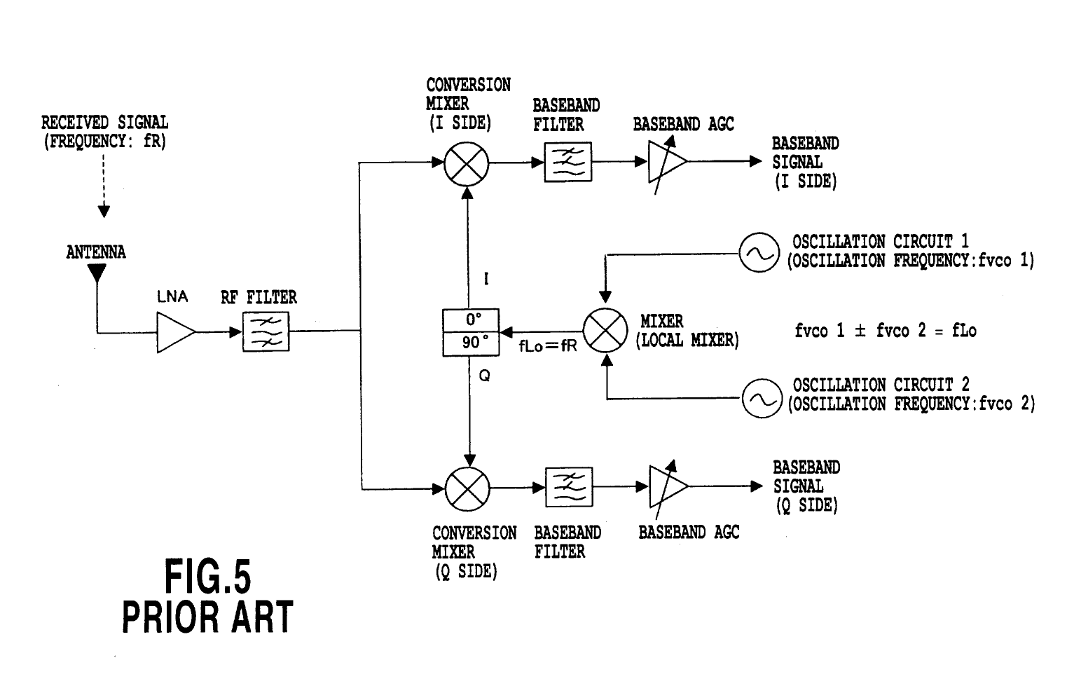

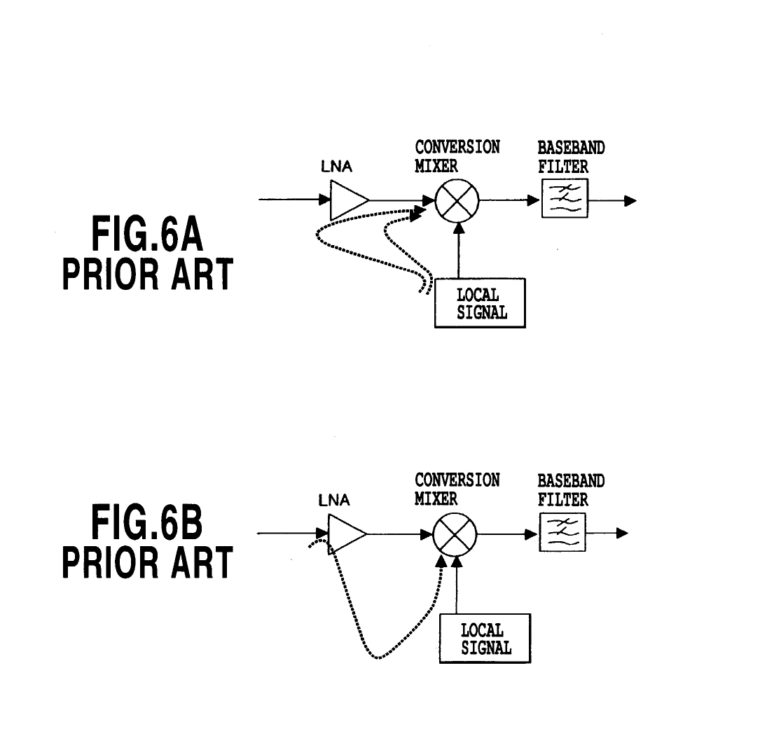

### DETAILED DESCRIPTION OF PREFERRED EMBODIMENTS

The invention will now be described with reference to the accompanying drawings.

Embodiment 1

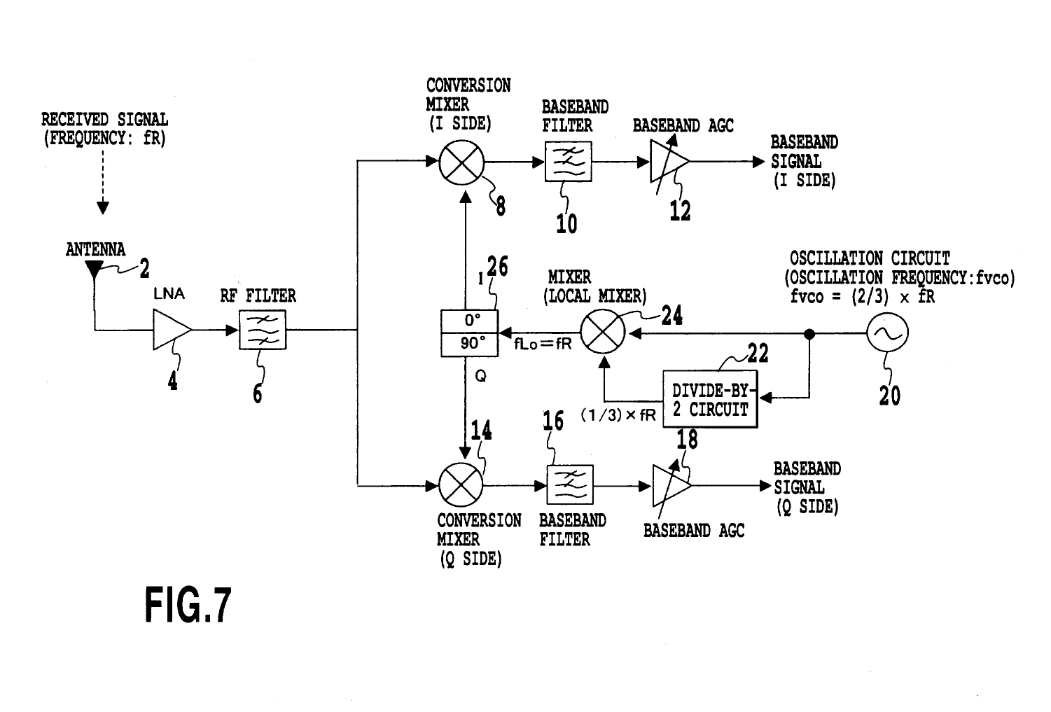

FIG. 7 shows a configuration of the direct conversion receiving unit in accordance with the present invention.

The present embodiment 1 includes only one oscillation circuit 20, the oscillation frequency fvco of which is set at fvco=(⅔)×fR for the receiving frequency fR of the communication system to which the present embodiment 1 is applied.

The output of the oscillation circuit 20 is split into two parts, one of which is supplied to a divide-by-2 circuit 22 that outputs the frequency (⅓×fR) as the divide-by-2 output. A local mixer 24, receiving the divide-by-2 output (⅓)×fR and the frequency fvco, outputs the frequency fR. Thus, the mixing of the local mixer 24 has the following frequency relationship.

(⅓)×fR+(⅔)×fR=fR

The local mixer output with the frequency fR is used as the local input to conversion mixers 8 and 14 to implement the direct conversion.

The present embodiment 1 includes only one oscillation circuit 20, and excludes all the circuits that operate at a frequency higher than fR. Consequently, it can implement a small size and low power consumption direct conversion receiving unit.

In addition, since the oscillation circuit 20 has the frequency greatly different from the frequency fR (the difference is (⅓×fR), it can adequately circumvent the problem of the desensitization due to the self-mixing together with the problem of the oscillation destabilization.

The local mixer 24 may generate frequencies other than the frequency fR as spurious sideband, a typical one of which is given by

(⅔)×fR−(⅓)×fR=(⅓)×fR.

To circumvent it, the local mixer 24 can have a configuration of the so-called single sideband mixer.

Furthermore, to remove output frequency components other than the frequency fR of the local mixer 24, a filter (not shown) may be interposed between the output of the local mixer 24 and the local inputs of the conversion mixers 8 and 14.

Embodiment 2

The present invention is also applicable to a receiving unit that replaces the divide-by-2 circuit 22 in the configuration of FIG. 7 by a more general divide-by-N circuit, where N is an integer greater than one.

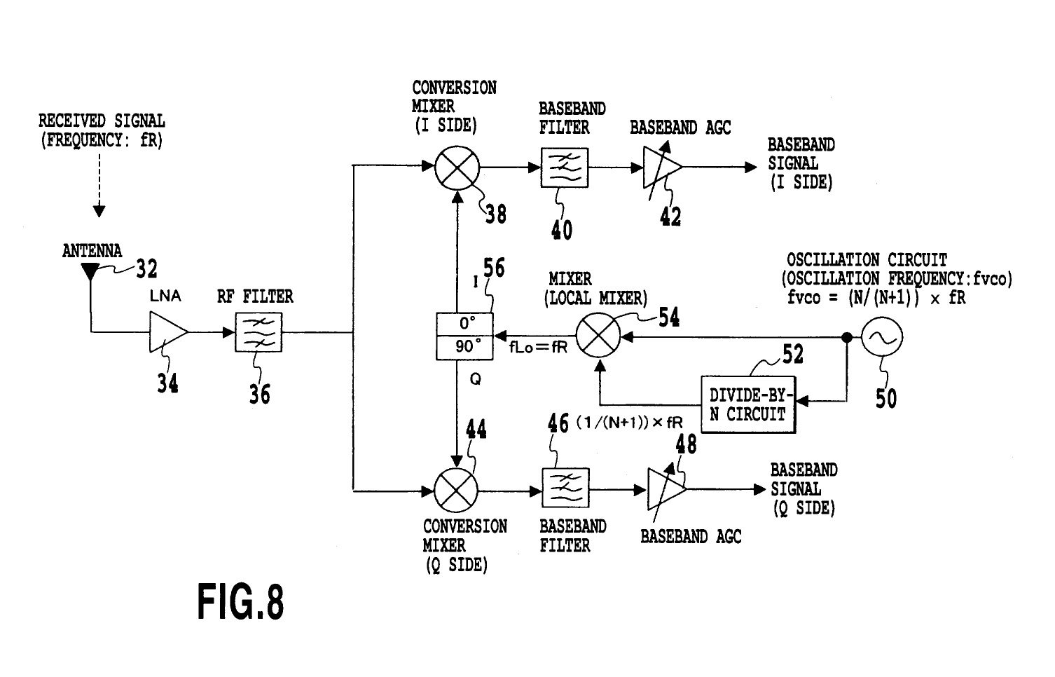

FIG. 8 shows such an embodiment, in which the output frequency of an oscillation circuit 50 is set at fvco=(N/(N+1))×fR. Accordingly, the output frequency of the divide-by-N circuit 52 is (1/(N+1))×fR, and the mixing by the local mixer 54 has the following frequency relationship.

(1/(N+1))×fR+(N/(N+1))×fR=fR

Since the difference between the frequencies fvco and fR is (1/(N+1))×fR, the value (fR−fvco) can be set sufficiently great as long as the value N is small enough with respect to the frequency fR. Thus, the present embodiment can circumvent the problem of the desensitization due to the self-mixing, and the problem of the oscillation destabilization.

The present embodiment 2 can also implement the small size and low power consumption direct conversion receiving unit as the embodiment 1. As for the Selection of N in the Embodiment 2.

As for the selection of the number N, there are other factors to be considered than selecting it in such a manner that the difference between the frequencies fvco and fR, that is, (1/(N+1))×fR becomes large enough. First, consider a communication system in which the frequency fR is fixed. In such a system, the smaller the number N, the lower the frequency fvco becomes, thereby reducing the size of the divide-by-N circuit 52 itself. Consequently, in terms of reducing the size and current consumption, it is preferable that the number N be as small as possible, and two is the best.

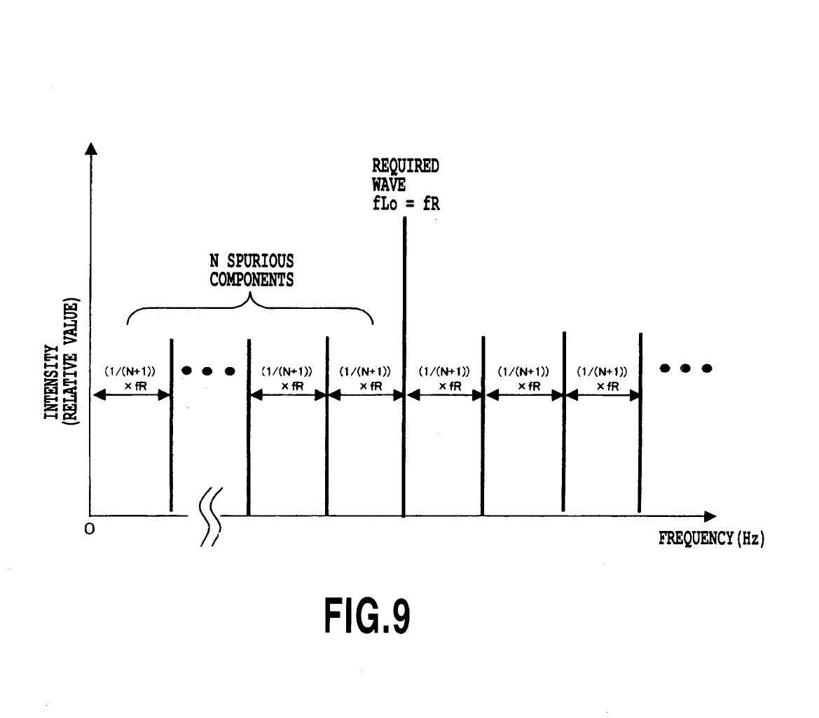

FIG. 9 illustrates a general frequency spectrum of a local mixer output. As described above, (spurious) frequencies other than the desired frequency fR can be removed by using a single sideband mixer configuration or a filter. This is because the spurious components, which are supplied to the local inputs of the conversion mixers 38 and 44, constitute the receiving spurious response frequencies of the direct conversion receiving unit.

It is possible, however, to reduce the adverse effect of the receiving spurious response frequencies on the system by selecting the number N appropriately in accordance with the system by considering the frequency components involved in the spurious oscillation in detail. The choice of the number N may obviate the need of the single sideband mixer configuration or the filter, or enable using a simpler filter with lower performance. In such a case, the size and current consumption reduction can be achieved by a simpler configuration.

Other Embodiments

Although the foregoing description is made by way of example of the direct conversion receiving unit using the I and Q quadrature demodulation for the convenience of the drawings, this is not essential. Since the subject matter of the present invention is the allocation system of the local input frequencies to the conversion mixer, the present invention is applicable to the demodulation other than the quadrature demodulation in exactly the same way.

In addition, although the foregoing description handles the case where the quadrature demodulation employs the conversion mixers that have phase differences of zero degree and 90 degrees at the local input side in figures, the present invention is not limited to the example. The present invention is also applicable to a quadrature demodulation configuration including the conversion mixer whose phase difference is 90 degrees at the input side of the received signal because of the same reason as described above.

As described above, the direct conversion receiving unit in accordance with the present invention requires only one oscillation circuit, and can implement the size and current consumption reduction because it excludes all the circuits that handle the frequency higher than the receiving frequency fR.

According to the present invention with the foregoing configurations, it is possible to circumvent the problems of the desensitization due to the self-mixing and oscillation destabilization, thereby being able to implement an intensely practical system.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A direct conversion receiving unit for receiving a received signal with a receiving frequency fR, said receiving unit comprising:
an oscillation circuit for generating an oscillation signal with an oscillation frequency of {N/(N+1)}·fR, where N is an integer greater than one;
a frequency conversion circuit for receiving the oscillation signal with the oscillation frequency of {N/(N+1)}·fR, and for converting the oscillation signal to a signal with an output frequency of fR; and
a mixer for receiving the received signal with the receiving frequency of fR, and the signal with the output frequency of fR which said frequency conversion circuit outputs, and for restoring a baseband signal received.

2. The direct conversion receiving unit as claimed in claim 1, wherein said frequency conversion circuit comprises:
a divide-by-N circuit for receiving the oscillation signal with the oscillation frequency of {N/(N+1)}·fR, and for producing a signal with an output frequency of {1/(N+1)}·fR; and
a mixer for receiving the oscillation signal with the oscillation frequency of {N/(N+1)}·fR from said oscillation circuit and the signal with the output frequency of {1/(N+1)}·fR from said divide-by-N circuit, and for producing the signal with the output frequency of fR.

3. The direct conversion receiving unit as claimed in claim 2, wherein said mixer is in the form of single sideband mixing.

4. The direct conversion receiving unit as claimed in claim 1, wherein the number N is two.

5. The direct conversion receiving unit as claimed in claim 2, wherein the number N is two.

6. The direct conversion receiving unit as claimed in claim 3, wherein the number N is two.
